(19) United States
(12) Patent Application Publication
(10) Pub. No.: US 2026/0077776 A1
(43) Pub. Date: Mar. 19, 2026

(54) VEHICLE CONTROL DEVICE AND VEHICLE CONTROL METHOD

(71) Applicant: HONDA MOTOR CO., LTD., Tokyo (JP)

(72) Inventors: Shinichi Okunishi, Tokyo (JP); Shun Iwasaki, Tokyo (JP)

(21) Appl. No.: 19/318,416

(22) Filed: Sep. 4, 2025

(30) Foreign Application Priority Data
Sep. 18, 2024 (JP) 2024-161207

(51) Int. Cl. B60W 50/029; B60W 10/20; B60W 50/02; B60W 50/04

(52) U.S. Cl. CPC B60W 50/029; B60W 10/20; B60W 50/0205; B60W 50/04; B60W 2050/0215; B60W 2420/403; B60W 2420/408; B60W 2710/20; B60W 2710/305; B60W 2720/10

(57) ABSTRACT

A vehicle control device includes an external sensor, a processing device performing a predetermined process associated with a vehicle, a control device controlling traveling of the vehicle, and a power supply supplying electric power to the external sensor and the processing device. The external sensor includes a first sensor, a second sensor, and a third sensor, the processing device includes a first processing device and a second processing device, outputs of the first sensor and the second sensor are output to the first processing device, and an output of the third sensor is output to the second processing device. The power supply includes a first power supply and a second power supply, the first power supply supplies electric power to the first sensor, the third sensor, and the first processing device, and the second power supply supplies electric power to the second sensor and the second processing device.

### CROSS-REFERENCE TO RELATED APPLICATION

Priority is claimed on Japanese Patent Application No. 2024-161207, filed Sep. 18, 2024, the content of which is incorporated herein by reference.

### BACKGROUND

### Field of the Invention

The present invention relates to a vehicle control device and a vehicle control method.

### Description of Related Art

Recently, countermeasures for providing access to a sustainable transportation system in which vulnerable persons out of traffic participants are considered have been actively studied. In order to realize such countermeasures, focus has been concentrated on research and development for further improving safety or convenience of traffic through research and development on preventive safety technology. In this regard, a technique in which a first traveling control means includes a first monitor monitoring communication situations of a first communication means and a second communication means, a second traveling control means includes a second monitor monitoring communication situations of a third communication means and a fourth communication means, and at least one of the first traveling control means and the second traveling control means performs alternative control when malfunction of a vehicle is detected on the basis of the communication situations monitored by the first monitor or the second monitor is known in the related art (for example, PCT International Publication No. 2019/116870). A technique of transmitting defect information to a normal controller group other than a defective controller group including a defective controller via a network communication line when a defect is determined to have occurred in one of a plurality of controllers and backing up an operating function lost due to the defect using controllers of the normal controller group until a driver returns to an operation when the normal controller group receives the defect information via the network communication line is also known in the related art (for example, PCT International Publication No. 2020/016622). A technique of providing a first control device controlling a vehicle on the basis of a detection result from a first sensor which operates with supply of electric power from a first power supply and a second control device controlling the vehicle on the basis of a detection result from a second sensor which operates with supply of electric power from a second power supply and controlling the vehicle using the second sensor when the first sensor is defective is also known in the related art (for example, Japanese Unexamined Patent Application, First Publication No. 2023-010252).

### SUMMARY

In such preventive safety technology, a redundant configuration needs to be adjusted according to a type of an external sensor detecting a surrounding situation of a vehicle, and there is room for study on a redundant configuration which is appropriate for an external sensor mounted in a vehicle.

The present invention was made in consideration of the aforementioned circumstances, and an objective thereof is to provide a vehicle control device and a vehicle control method that can construct a redundant configuration which is more appropriate for an external sensor mounted in a vehicle. Another objective of the present invention is to contribute to development of a sustainable transportation system.

A vehicle control device and a vehicle control method according to the present invention employ the following configurations.

(1) A vehicle control device according to an aspect of the present invention is a vehicle control device including: an external sensor detecting a surrounding situation of a vehicle; a processing device performing a predetermined process associated with the vehicle on the basis of an output of the external sensor; a control device controlling at least traveling of the vehicle on the basis of a process result of the processing device; and a power supply supplying electric power to at least the external sensor and the processing device, wherein the external sensor includes a first sensor, a second sensor, and a third sensor, the processing device includes a first processing device and a second processing device, outputs of the first sensor and the second sensor are output to the first processing device, an output of the third sensor is output to the second processing device, the power supply includes a first power supply and a second power supply, the first power supply supplies electric power to at least the first sensor, the third sensor, and the first processing device, and the second power supply supplies electric power to at least the second sensor and the second processing device.

(2) In the aspect of (1), each of the first sensor and the second sensor includes a plurality of cameras imaging areas in a plurality of different directions from the vehicle, and the third sensor includes a plurality of radar devices detecting objects in a plurality of different directions from the vehicle.

(3) In the aspect of (1), each of the first sensor and the second sensor includes a plurality of cameras having the same usage or the same angle of view, and the third sensor includes a plurality of radar devices detecting objects in a plurality of different directions from the vehicle.

(4) In the aspect of (1), the second sensor is connected to the first processing device via a first communication line and is connected to the second processing device via a second communication line which is different from the first communication line.

(5) In the aspect of (4), the first communication line is a communication network having a larger capacity and a higher communication speed than the second communication line.

(6) In the aspect of (1), the first processing device has a larger processing capacity than the second processing device.

(7) In the aspect of (1), the first processing device generates a target trajectory of the vehicle on the basis of an output of the external sensor, and the second processing device outputs an instruction to an actuator device included in the control device on the basis of the target trajectory generated by the first processing device.

(8) In the aspect of (7), the actuator device includes a steering control device controlling steering of the vehicle and a speed control device controlling a speed of the vehicle, and the steering control device and the speed control device include a communication line via which an instruction from the second processing device is able to be received and a communication line via which an instruction from the first processing device is able to be received.

(9) In the aspect of (1), the first power supply supplies electric power to a first group including at least the first sensor, the third sensor, and the first processing device, and the second power supply supplies electric power to a second group including at least the second sensor and the second processing device. When one group of the first group and the second group is determined to be defective, the control device determines a stop position of the vehicle from the surrounding situation of the vehicle using the other group and performs vehicle control for causing the vehicle to travel to the determined stop position.

(10) A vehicle control method according to another aspect of the present invention is a vehicle control method including: causing an external sensor to detect a surrounding situation of a vehicle; causing a processing device to perform a predetermined process associated with the vehicle on the basis of an output of the external sensor; controlling at least traveling of the vehicle on the basis of a process result of the processing device; and causing a power supply to supply electric power to at least the external sensor and the processing device, wherein the external sensor includes a first sensor, a second sensor, and a third sensor, the processing device includes a first processing device and a second processing device, outputs of the first sensor and the second sensor are output to the first processing device, an output of the third sensor is output to the second processing device, the power supply includes a first power supply and a second power supply, the first power supply supplies electric power to at least the first sensor, the third sensor, and the first processing device, and the second power supply supplies electric power to at least the second sensor and the second processing device.

According to the aspects of (1) to (10), it is possible to construct a redundant configuration which is more appropriate for an external sensor mounted in a vehicle.

### BRIEF DESCRIPTION OF THE DRAWINGS

FIG. 1 is a diagram illustrating a configuration of a vehicle system including a vehicle control device according to an embodiment.

FIG. 2 is a diagram illustrating a functional configuration of a first processor according to the embodiment.

FIG. 3 is a diagram illustrating an example of arrangement of external sensors according to the embodiment.

FIG. 4 is a diagram illustrating an example of a redundant configuration including supply of electric power according to the embodiment.

FIG. 5 is a diagram schematically illustrating detection ranges of sensors included in the external sensors according to the embodiment.

### DESCRIPTION OF EMBODIMENTS

Hereinafter, a vehicle control device and a vehicle control method according to an embodiment of the present invention will be described with reference to the accompanying drawings.

### [Entire Configuration]

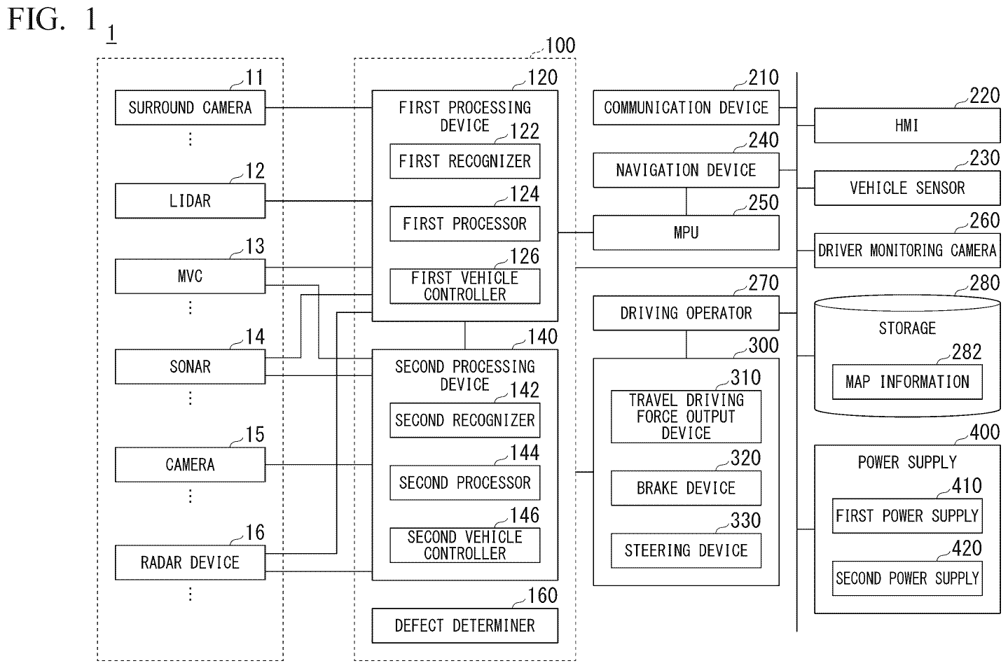

FIG. 1 is a diagram illustrating a configuration of a vehicle system 1 including a vehicle control device according to an embodiment. A vehicle (hereinafter, referred to as a vehicle M) in which the vehicle system 1 is mounted is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell.

The vehicle system 1 includes, for example, an external sensor (an outside detector) 10 including a plurality of types of sensors, a processing device 100, a communication device 210, a human-machine interface (HMI) 220, a vehicle sensor 230, a navigation device 240, a map positioning unit (MPU) 250, a driver monitoring camera 260, a driving operator 270, a storage 280, a traveling control device 300, and a power supply 400. These devices or instruments are connected to each other via a multiplex communication line such as a controller area network (CAN) communication line or Ethernet (registered trademark), a serial communication line, a radio communication network, or the like. Ethernet is a communication network having a larger capacity and a higher communication speed than the CAN communication line. The configuration illustrated in FIG. 1 is only an example, and a part of the configuration may be omitted or another configuration may be added thereto. The functional constituents may be integrated or may be distributed. The traveling control device 300 is an example of a “control device.” The external sensor 10, the processing device 100, the traveling control device 300, and the power supply 400 are an example of a “vehicle control device.”

The external sensor 10 detects a situation near the vehicle M (within a predetermined distance from the vehicle M). The external sensor 10 includes, for example, an all-around camera 11, a Light Detection and Ranging (LIDAR) device 12, a multi-view camera (MVC) 13, a sonar 14, a camera 15, and a radar device 16. The numbers of at least some of the all-around camera 11, the MVC 13, the sonar 14, the camera 15, and the radar device 16 in the external sensor 10 may be two or more. The all-around camera 11 is an example of a “first sensor,” the MVC 13 is an example of a “second sensor,” and the radar device 16 is an example of a “third sensor.” The first sensor may include the camera 15 in addition to the all-around camera 11.

The all-around camera 11 is a camera that is installed in a perimeter including at least the left and right sides and the rear side of a vehicle body (a body of the vehicle M). The all-around camera 11 may be, for example, a digital camera using a solid-state imaging device such as a charge coupled device (CCD) or a complementary metal oxide semiconductor (CMOS) or may be a stereo camera. The all-around camera 11 senses at least about several [m] ahead on the left and right sides and the rear side of the vehicle M (which include the top side of the vehicle M) and acquires images of areas including the lateral side and the rear side of the vehicle M. The all-around camera 11 may acquire an all-around image of the vehicle M including an image captured by the camera 15.

The LIDAR device 12 radiates light (or electromagnetic waves of wavelengths close to light) to the surroundings of the vehicle M and measures scattered light. The LIDAR device 12 detects a distance to a nearby object on the basis of a time period from radiation of light to reception of light. The radiated light is, for example, a pulse-like laser beam. The LIDAR device 12 is installed, for example, in a roof of the vehicle and senses a nearby object including the front side of the vehicle M. The LIDAR device 12 may be attached to an arbitrary other position.

The MVC 13 is a camera that is installed on the front, rear, left, and right sides of the vehicle body. The MVC 13 may be, for example, a digital camera using a solid-state imaging device such as a CCD or a CMOS or may be stereo camera. The MVC 13 may be a wide-angle camera such as a fish-eye camera (that is, a camera with a wider imaging range than the all-around camera 11 or the camera 15). The MVC 13 senses the surroundings (mainly the vicinity of the ground surface) of the vehicle M and acquires a surrounding image. For example, a dead-angle area of a driver of the vehicle M is imaged by the MVC 13.

The sonar 14 detects a distance to an object or a position of the object by radiating ultrasonic waves to the surroundings of the vehicle M and detecting reflection or scattering from an object which is located within a predetermined distance from the vehicle M. A plurality of sonars 14 are installed at arbitrary positions on the vehicle M.

The camera 15 is installed at an arbitrary position on the vehicle M and images an area including at least a space in front of the vehicle M. The camera 15 may be, for example, a digital camera using a solid-state imaging device such as a CCD or a CMOS or may be stereo camera. A plurality of cameras 15 may be provided.

The radar device 16 detects at least a position (a distance and a direction) of an object by radiating radio waves such as millimeter waves to the surroundings of the vehicle M and detecting radio waves (reflected waves) reflected by the object. The radar device 16 is attached to an arbitrary position on the vehicle M. The radar device 16 may detect a position and a speed of an object using a frequency modulated continuous wave (FM-CW) method.

Details of an installation position of the external sensor 10 will be described later. Other constituents may be mounted in the external sensor 10. The external sensor 10 may not include some types of sensors (for example, the LIDAR 12) according to grades, generations (versions), functions, or the like of the vehicle M or may include other constituents. The external sensor 10 performs sensing, for example, in a predetermined period and outputs a result (a detection result) thereof to the processing device 100.

The processing device 100 performs a predetermined process associated with the vehicle M. The processing device 100 includes, for example, a first processing device 120, a second processing device 140, and a defect determiner 160. The first processing device 120, the second processing device 140, and the defect determiner 160 are realized, for example, by causing a hardware processor such as a central processing unit (CPU) to execute a program (software). Some or all of such constituents may be realized by hardware (a circuit part including circuitry) such as a large scale integration (LSI) device, an application-specific integrated circuit (ASIC), or a field-programmable gate array (FPGA), a graphics processing unit (GPU), or a system-on-chip (SOC) or may be cooperatively realized by software and hardware. The program may be stored in a device (a storage device including a non-transitory storage medium) such as a hard disk drive (HDD) or a flash memory of the processing device 100 (or the vehicle system 1) in advance, or may be stored in a removable storage medium such as a DVD or a CD-ROM and installed in the HDD or the flash memory of the processing device 100 (or the vehicle system 1) by setting the storage medium (a non-transitory storage medium) into a drive device.

The first processing device 120 is, for example, an electronic control unit (ECU) that performs driving control including automated driving of the vehicle M. The second processing device 140 is an ECU that performs driving control including driving support control such as an advanced driver assistance system (ADAS) for supporting driving of a driver of the vehicle M. Driving control is, for example, automatically controlling one or both of steering and a speed of the vehicle M such that driving control is performed. Examples of driving control include, for example, lane keeping assistance system (LKAS), an adaptive cruise control (ACC) system, auto lane changing (ALC), traffic jam pilot (TJP), and a collision mitigation brake system (CMBS). Driving control may include minimum risk maneuver (MRM) control for moving the vehicle M to a safe place (for example, a roadside) and stopping the vehicle M.

In driving control in the first processing device 120, all driving control is basically performed by a system (the vehicle system 1) side, and thus driving control for controlling the steering and the speed of the vehicle M regardless of a driver's driving operation is performed, but the driver performs a driving operation (manual driving) when the system side requests the driver for intervention. On the other hand, in driving control in the second processing device 140, one of the steering and the speed is controlled by the system side and the other is controlled according to a driver's driving operation, or only specific driving control such as LKAS or ACC is performed by the system side. The driving control in the second processing device 140 may include control for giving a warning or an alarm to a driver or control for providing information (an image or speech) associated with driving support. Specific functional configurations of the first processing device 120 and the second processing device 140 will be described later.

The defect determiner 160 determines whether a defect (an abnormality) has occurred in the first processing device 120 and the second processing device 140 on the basis of the detection results acquired from the vehicle sensor 230 or the like. A defect is, for example, a situation in which driving control in at least one of the first processing device 120 and the second processing device 140 does not work correctly or does not work at all due to an abnormality in hardware, software, or the like. The defect may include an influence of an abnormality in the power supply 400. The defect determiner 160 causes a predetermined process or the like associated with the vehicle M such as nearby object recognition or driving control to be performed using normal constituents out of redundant constituents which will be described later on the basis of the determination result. For example, when one of the first processing device 120 and the second processing device 140 is determined to be defective, the defect determiner 160 performs driving control such as MRM using the other processing device.

The communication device 210 communicates with other vehicles near the vehicle M, for example, using a cellular network, a Wi-Fi network, Bluetooth (registered trademark), or dedicated short range communication (DSRC) or communicates with various server devices via radio base stations.

The HMI 220 presents various types of information to an occupant (who includes a driver) of the vehicle M and receives an input operation from the occupant. The HMI 220 includes, for example, a display and a speaker. Examples of the display include a liquid crystal display (LCD) device and an organic electroluminescence (EL) display device. The display is provided, for example, in an instrument panel or a meter display. The display displays various types of images (which include videos) according to the embodiment. The display may be unified with an input as a touch panel. The speaker outputs predetermined sound (for example, an alarm) into the cabin. The HMI 220 may include a microphone, a buzzer, and keys in addition to the display and the speaker. The HMI 220 may include a head-up display (HUD).

The vehicle sensor 230 includes various sensors used for control of the vehicle M such as a vehicle speed sensor that detects a speed of the vehicle M, an acceleration sensor that detects an acceleration, a yaw rate sensor that detects an angular velocity around a vertical axis, and a direction sensor that detects a direction of the vehicle M. The vehicle sensor 230 may include a position sensor that detects a position of the vehicle M. The position sensor is, for example, a sensor that acquires position information (longitude and latitude information) from a global positioning system (GPS) device. The position sensor may be a sensor that acquires position information using a global navigation satellite system (GNSS) receiver of the navigation device 240. The vehicle sensor 230 may include a measuring sensor that measures states of the power supply 400 (for example, a temperature, a residual battery capacity, a current value, and a voltage value) or a measuring sensor that measures states of electrical lines or communication lines (disconnection or other communication errors) which will be described later.

The navigation device 240 includes, for example, a GNSS receiver, a navigation HMI, and a route determiner. The navigation device 240 identifies the position of the vehicle M on the basis of signals received from GNSS satellites. The position of the vehicle M may be identified or corrected by an inertial navigation system (INS) using the output of the vehicle sensor 230. The navigation HMI includes a display device, a speaker, a touch panel, and keys. The navigation HMI may be partially or wholly shared by the HMI 220. For example, the route determiner determines a route (hereinafter referred to as a route on a map) from the position of the vehicle M identified by the GNSS receiver (or an input arbitrary position) to a destination input by an occupant using the navigation HMI with reference to map information 282 stored in the storage 280.

The map information 282 is, for example, information in which a road shape is expressed by links indicating a road and nodes connected by the links. The map information 282 may include point of interest (POI) information. For example, the map information 282 may include information of lane centers and information of lane boundaries (such as lane markings). The map information 282 may include road information, traffic regulation information, address information (addresses and postal codes), facility information, and phone number information. The road information may include, for example, road type information such as an expressway or a regular road, road shape information such as a junction, a branch, a T junction, or a curvature (or a radius of curvature), and other road information such as the number of lanes, a road gradient, a junction (JCT), a service area, a toll gate, and a zebra zone (a buffer zone). The map information 282 may be updated from time to time by causing the communication device 210 to communicate with another device. The map information 282 may be stored in a storage device such as an HDD or a flash memory of the navigation device 240.

The navigation device 240 may perform route guidance using the navigation HMI on the basis of the route on a map. The navigation device 240 may be realized, for example, by a function of a terminal device such as a smartphone or a tablet terminal which is carried by an occupant. The navigation device 240 may transmit a current position and a destination to a navigation server via the communication device 210 and acquire a route which is equivalent to the route on a map from the navigation server.

For example, the MPU 250 divides the route on a map determined by the navigation device 240 into a plurality of blocks (for example, every 100 [m] in a vehicle traveling direction) and determines a recommended lane for each block with reference to the map information 282. For example, the MPU 250 determines on which lane from the leftmost the vehicle is to travel. When there is a branching point in the route on a map, the MPU 250 determines the recommended lane such that the vehicle M can travel along a rational route for traveling to a branching destination. The MPU 250 recognizes the position of the vehicle M on the basis of a detection result from a gyro sensor which is not illustrated, the position of the vehicle M identified by the GNSS receiver, or the like.

The driver monitoring camera 260 is, for example, a digital camera using a solid-state imaging device such as a CCD or a CMOS. The driver monitoring camera 260 is attached to an arbitrary position on the vehicle M in a place and a direction in which the head of a driver sitting on a driver's seat of the vehicle M can be imaged from the front (in a direction in which the face of the driver is imaged). For example, the driver monitoring camera 260 is attached to an upper part of a display device which is provided at the center of the instrument panel of the vehicle M.

The driving operator 270 includes, for example, a steering wheel, an accelerator pedal, a brake pedal, a shift lever, and other operators. A sensor that detects an amount of operation or whether an operation has been performed is attached to the driving operator 270, and results of detection of the sensor are output to the processing device 100 or the traveling control device 300. For example, the steering wheel may be formed in a ring shape or may have a shape of a deformed steering wheel, a joystick, a button, or the like. A steering wheel grasp sensor is attached to the steering wheel. The steering wheel grasp sensor is realized by a capacitance sensor or the like and outputs a signal indicating whether a driver grasps the steering wheel (which means contacting the steering wheel with a force applied thereto) to the processing device 100.

The storage 280 may be realized by the aforementioned various storage devices or an electrically erasable programmable read only memory (EEPROM), a read only memory (ROM), a random access memory (RAM), or the like. For example, the map information 282, various types of information in the embodiment, and programs may be stored in the storage 280.

The traveling control device 300 causes the vehicle M to travel with a predetermined speed or predetermined steering on the basis of control information from the processing device 100 or operation details on the driving operator 270. The traveling control device 300 includes, for example, a travel driving force output device 310, a brake device 320, and a steering device 330. The travel driving force output device 310 and the brake device 320 are an example of a “speed control device.” The steering device 330 is an example of a “steering control device.” The speed control device and the steering control device are an example of an actuator device including an actuator (an activator). The actuator device included in the vehicle M additionally includes an air-conditioning device, a power window device (an automatic window opening/closing device), and a wiper device.

The travel driving force output device 310 outputs a travel driving force (a torque) for allowing the vehicle M to travel to driving wheels. The travel driving force output device 310 includes, for example, a combination of an internal combustion engine, an electric motor, and a transmission and an electronic control unit (ECU) that controls them. The ECU controls the constituents on the basis of information input from the first processing device 120 or the second processing device 140 or information input from an accelerator pedal of the driving operator 270.

The brake device 320 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of information input from the first processing device 120 or the second processing device 140 or information input from a brake pedal of the driving operator 270 such that a brake torque based on a braking operation is output to vehicle wheels. The brake device 320 may include a mechanism for transmitting a hydraulic pressure generated by an operation of the brake pedal to the cylinder via a master cylinder as a backup. The brake device 320 is not limited to the above-mentioned configuration and may be an electronically controlled hydraulic brake device that controls an actuator on the basis of information input from the first processing device 120 or the second processing device 140 such that the hydraulic pressure of the master cylinder is transmitted to the cylinder.

The steering device 330 includes, for example, a steering ECU and an electric motor. The electric motor changes a direction of turning wheels, for example, by applying a force to a rack-and-pinion mechanism. The steering ECU drives the electric motor on the basis of information input from the first processing device 120 or the second processing device 140 or information input from the steering wheel of the driving operator 270 to change the direction of the turning wheels.

The power supply 400 supplies electric power to the devices of the vehicle system 1 including at least the external sensor 10 and the processing device 100. The power supply 400 includes, for example, a first power supply 410 and a second power supply 420. The first power supply 410 and the second power supply 420 are, for example, chargeable/dischargeable batteries (secondary batteries). The power supply 400 supplies electric power to the devices from at least one of the first power supply 410 and the second power supply 420. For example, the first power supply 410 supplies electric power to the all-around camera (first sensor) 11, the radar device (third sensor) 16, the first processing device 120, and the like. For example, the second power supply 420 supplies electric power to the MVC (second sensor) 13, the second processing device 140, and the like. The power supply 400 may be made to be redundant such that electric power is supplied from the other when an abnormality occurs in one of the first power supply 410 and the second power supply 420. Details of supply of electric power using the power supply 400 will be described later.

### [First Processing Device 120]

The functional configuration of the first processing device 120 will be specifically described below. The first processing device 120 includes, for example, a first recognizer 122, a first processor 124, and a first vehicle controller 126.

The first recognizer 122 performs a sensor fusion process on outputs (detection results) from at least some of a plurality of sensors included in the external sensor 10 and recognizes a surrounding situation of the vehicle M. For example, the first recognizer 122 performs a sensor fusion process using the detection results from the all-around camera 11, the LIDAR 12, and the radar device 16. The first recognizer 122 may perform a sensor fusion process using detection results from other constituents (for example, the MVC 13, the sonar 14, and the camera 15) in addition to (or instead of) the aforementioned types of the external sensor 10. For example, the first recognizer 122 recognizes a position, a type, a speed, and the like of an object near the vehicle M (within a predetermined distance therefrom) from a result of the sensor fusion process. For example, a position of an object is recognized as a position in an absolute coordinate system with a representative point (such as the center of gravity or the center of a drive shaft) of the vehicle M as an origin and is used for control. A position of an object may be expressed as a representative point such as the center of gravity or a corner of the object or may be expressed as an area. A “state” of an object may include an acceleration or a jerk of the object or a “moving state” (for example, whether lane change is being performed or whether lane change is going to be performed) thereof.

The first recognizer 122 recognizes, for example, road marking lines near the vehicle M from an image acquired by the external sensor 10 and recognizes a lane (a traveling lane) in which the vehicle M is traveling. In this case, the first recognizer 122 may recognize the traveling lane by comparing a pattern of road marking lines near the vehicle M recognized by the external sensor 10 with a pattern of road marking lines acquired from the map information 282 (for example, arrangement of solid lines and dotted lines) on the basis of the position information of the vehicle M. The first recognizer 122 is not limited to the road marking lines, and may recognize the traveling lane by recognizing traveling lane boundaries (road boundaries) including edges of roadsides, curbstones, median strips, and guard rails from the image or the map information 282. In this recognition, the position of the vehicle M acquired from the vehicle sensor 230 or the navigation device 240 or the result of processing from the INS may be considered. The first recognizer 122 recognizes a stop line, an obstacle, a red signal, a toll gate, or other road events.

The first recognizer 122 recognizes a position or a posture of the vehicle M with respect to the traveling lane at the time of recognition of the traveling lane. The first recognizer 122 may recognize, for example, a degree of separation of a reference point of the vehicle M from the lane center and an angle of the traveling direction of the vehicle M with respect to a line formed by connecting the lane centers as the relative position and the relative posture of the vehicle M with respect to the traveling lane. Instead, the first recognizer 122 may recognize a position of a reference point of the vehicle M with respect to one side line (a road marking line or a road boundary) of the traveling lane or the like as the relative position of the vehicle M with respect to the traveling lane.

For example, the first recognizer 122 realizes a function based on artificial intelligence (AI) and a function based on a predetermined model together. For example, a function of “recognizing a crossing” may be realized by performing recognition of a crossing based on deep learning or the like and recognition based on predetermined conditions (such as signals and road signs which can be pattern-matched) together, scoring both recognitions, and comprehensively evaluating the recognitions. Accordingly, reliability of driving control such as automated driving is secured.

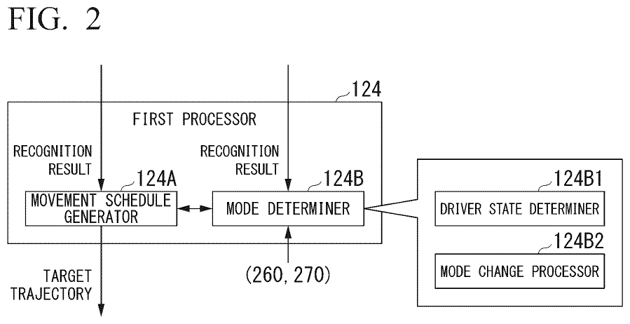

The first processor 124 performs driving control including automated driving of the vehicle M on the basis of the result of recognition from the first recognizer 122. FIG. 2 is diagram illustrating a functional configuration of the first processor 124 according to the embodiment. The first processor 124 includes, for example, a movement schedule generator 124A and a mode determiner 124B.

The movement schedule generator 124A generates a target trajectory along which the vehicle M will travel autonomously (without requiring a driver's operation) in the future such that the vehicle M can travel along a recommended lane determined by the MPU 250 in principle and cope with a surrounding situation of the vehicle M. The target trajectory includes, for example, a speed element. For example, the target trajectory is expressed by sequentially arranging points (trajectory points) at which the vehicle M is to arrive. Trajectory points are points at which the vehicle M is to arrive at intervals of a predetermined traveling distance (for example, about several [m]) along a road, and a target speed and a target acceleration at every interval of a predetermined sampling time (for example, several tenths [sec]) are generated as a part of the target 5 trajectory in addition thereto. The trajectory points may be positions at which the vehicle M is to arrive at sampling times every predetermined sampling time. In this case, information of the target speed or the target acceleration is expressed by intervals between the trajectory points.

The movement schedule generator 124A may set events of automated driving in generating a target trajectory. The events of automated driving include a constant-speed travel event, a low-speed following travel event, a lane change event, a branching event, a merging event, an overtaking event, and a degraded driving event. The movement schedule generator 124A generates a target trajectory based on an event which has started.

The mode determiner 124B determines a driving mode of the vehicle M to be one of a plurality of driving modes with different tasks to be imposed on a driver. The mode determiner 124B includes, for example, a driver state determiner 124B1 and a mode change processor 124B2.

Here, the vehicle system 1 can perform a plurality of driving modes of the vehicle M. The plurality of driving modes are, for example, modes with different control states, that is, with different automation levels of driving control of the vehicle M. A high automation level means that a degree of control with which the vehicle system 1 controls the vehicle M is high, that is, a degree of intervention with which a driver intervenes in control (a driving operation) of the vehicle M is low. Tasks to be imposed on a driver vary according to the automation level. For example, as the automation level becomes higher, the tasks become lighter. A task is, for example, forward monitoring of a driver, grasping of a steering wheel, or an accelerating/decelerating operation. For example, in a driving mode with a high automation level, forward monitoring of a driver, grasping of a steering wheel, or an accelerating/decelerating operation are not imposed on the driver, and automated driving in which steering control and speed control of the vehicle M are performed is performed. Forward refers to a space in front of the vehicle M in the traveling direction which is seen through a front windshield. For example, when conditions in which the vehicle Mis traveling at a predetermined speed (for example, about 60 [km/h]) or lower on a motorway such as a highway and a preceding vehicle to be followed is present are satisfied, a driving mode in which the aforementioned tasks are not imposed on the driver is performed. This driving mode may also be referred to as TJP. When these conditions are not satisfied, the mode determiner 124B changes the driving mode to another driving mode.

The mode determiner 124B changes the driving mode of the vehicle M to a driving mode with heavier tasks when it is determined that the driver has not performed a task associated with the determined driving mode (hereinafter referred to as a current driving mode) on the basis of information (for example, grasping of a steering wheel or forward monitoring by the driver) acquired from the driving operator 270, the driver monitoring camera 260, or the like. For example, in a driving mode with a high automation level, when the driver adopts a posture in which the driver cannot transition to manual driving in response to a request from a system (for example, when the driver continues to look aside outside of a permitted area or a sign indicating driving difficulty is detected), the mode determiner 124B prompts the driver to transition to manual driving using the HMI 220 or a predetermined output for prompting the driver to grasp the steering wheel and performs degraded driving control such that the vehicle Mis put on a road edge and slowly stopped and automated driving is stopped when the driver does not respond. After automated driving has been stopped, the vehicle M can be made to transition to a driving mode with a lower automation level and to start the vehicle M by the driver's manual operation. This is the same for “stopping of automated driving.”

The driver state determiner 124B1 monitors a driver's state for the mode change and determines whether the driver's state is a state corresponding to a task. For example, the driver state determiner 124B1 performs a posture estimating process by analyzing an image captured by the driver monitoring camera 260 and determines whether the driver has taken a posture with which the driver cannot transition to manual driving in response to a request from the system. The driver state determiner 124B1 performs a gaze estimating process by analyzing the image captured by the driver monitoring camera 260 and determines whether the driver is monitoring forward.

The mode change processor 124B2 performs various processes for mode change. For example, the mode change processor 124B2 instructs the movement schedule generator 124A to generate a target trajectory for degraded driving, instructs the second processing device 140 to operate, or controls the HMI 220 such that the driver is prompted to perform an action.

For example, the first vehicle controller 126 acquires information of the target trajectory (trajectory points) generated by the second processor 144 and stores the acquired information in a memory (not illustrated). The first vehicle controller 126 controls target actuators (the travel driving force output device 310, the brake device 320, and the steering device 330) such that the vehicle M travels along the target trajectory generated by the movement schedule generator 124A as scheduled. For example, the first vehicle controller 126 controls the travel driving force output device 310 or the brake device 320 on the basis of a speed element accessory to the target trajectory stored in the memory. The first vehicle controller 126 controls the steering device 330 on the basis of a curved state of the target trajectory stored in the memory. The process of the first vehicle controller 126 is realized, for example, by feed-forward control and feedback control in combination. For example, the first vehicle controller 126 performs driving control in combination of feed-forward control based on a curvature of a road in front of the vehicle M and feedback control based on a separation from the target trajectory such that the vehicle M travels along the target trajectory. The first vehicle controller 126 may provide the information of the target trajectory to the second processing device 140 and control the target actuators (the travel driving force output device 310, the brake device 320, and the steering device 330) via the second processing device 140. Accordingly, since communication lines (instruction systems) for the actuators can be unified, adjustment control or the like becomes unnecessary. Accordingly, since a process load can be reduced, it is possible to enable more appropriate (with a less time lag) operation control for the target actuators.

### [Second Processing Device 140]

The functional configuration of the second processing device 140 will be specifically described below. Referring back to FIG. 1, the second processing device 140 includes, for example, a second recognizer 142, a second processor 144, and a second vehicle controller 146.

The second recognizer 142 performs a sensor fusion process on detection results from at least some of a plurality of sensors included in the external sensor 10 and recognizes a surrounding situation of the vehicle M. For example, the second recognizer 142 performs a sensor fusion process using the detection results from the sonar 14 or the camera 15. The second recognizer 142 may perform a sensor fusion process using other constituents (for example, the radar device 16 or the MVC 13) in addition to (or instead of) the aforementioned types of the external sensor 10. For example, the second recognizer 142 recognizes a position, a type, a speed, and the like of an object near the vehicle M (within a predetermined distance therefrom) from a result of the sensor fusion process. The second recognizer 142 may have, for example, the same function as the first recognizer 122. The second recognizer 142 may be omitted and the process result from the first recognizer 122 may be used.

The second processor 144 performs driving control for supporting a driver's driving on the basis of the recognition result from the second recognizer 142. The second processor 144 generates a target trajectory along which the vehicle M will travel in the future on the basis of the traveling state of the vehicle M (the position or the speed of the vehicle M) or the surrounding situation (road conditions, positions of nearby objects, or the like). The second processor 144 may perform driving control of the vehicle M similarly to the first processor 124.

For example, the second vehicle controller 146 acquires information of the target trajectory (trajectory points) generated by the second processor 144 and stores the acquired information in a memory (not illustrated). The second vehicle controller 146 controls target actuators (the travel driving force output device 310, the brake device 320, and the steering device 330) on the basis of the target trajectory stored in the memory or the like. For example, the second vehicle controller 146 controls the travel driving force output device 310 or the brake device 320 on the basis of the target trajectory stored in the memory or the like or controls the steering device 330 on the basis of a curved state of the target trajectory stored in the memory or the like. Similarly to the first vehicle controller 126, the process of the second vehicle controller 146 may be realized by feed-forward control and feedback control in combination. The second vehicle controller 146 may perform driving control of the vehicle M on the basis of the target trajectory generated by the first processor 124. The second vehicle controller 146 may cause the HMI 220 to output information for prompting the driver to perform a predetermined driving operation (manual driving) such that the vehicle M travels along the target trajectory.

### [Arrangement of External Sensor 10]

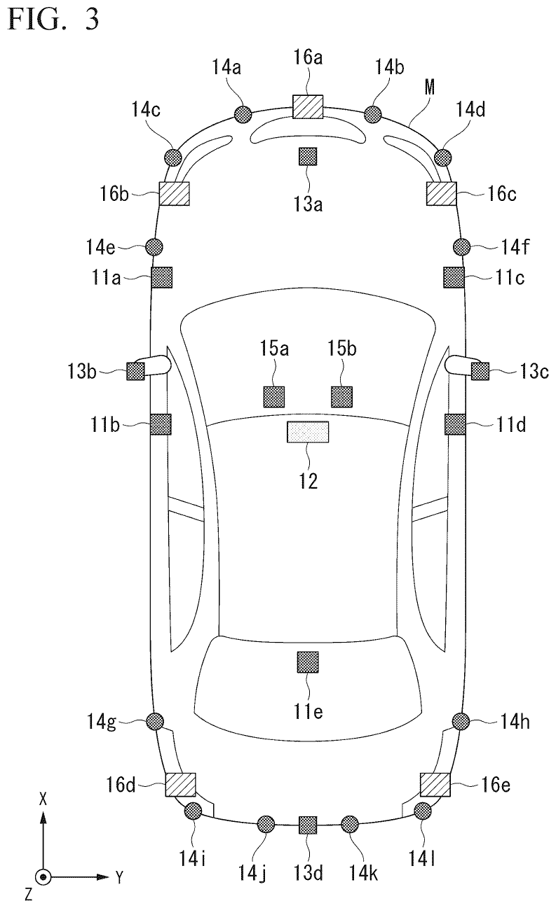

Details of arrangement of the external sensor 10 will be described below. FIG. 3 is a diagram illustrating an example of arrangement of the external sensor 10 according to the embodiment. In the example illustrated in FIG. 3, five all-around cameras 11a to 11e, one LIDAR 12, four MVCs 13a to 13d, 12 sonars 14a to 14l, two cameras 15a and 15b, and five radar devices 16a to 16e are provided in the vehicle M. In the following description, the all-around cameras 11a to 11e are referred to as an “all-around camera 11” unless they are individually distinguished. The same is true of the MVCs 13a to 13d, the sonars 14a to 14l, the cameras 15a and 15b, and the radar devices 16a to 16e.

In the embodiment, each of the all-around camera (first sensor) 11 and the MVC (second sensor) 13 includes a group of a plurality of cameras imaging areas in a plurality of different directions from the vehicle M (with respect to the vehicle M). The radar device (third sensor) 16 includes a group of a plurality of radar devices detecting objects present in a plurality of different directions from the vehicle M. The sonar 14 includes a group of a plurality of radars facing objects present in a plurality of different directions from the vehicle M.

In the example illustrated in FIG. 3, the all-around cameras 11a and 11b are installed on the left side of the vehicle body (the body of the vehicle M) and image an area including the left side (the −Y-axis direction in the drawing) of the vehicle M. The all-around cameras 11c and 11d are installed on the right side of the vehicle body and image an area including the right side (the Y-axis direction in the drawing) of the vehicle M. The all-around camera 11e is installed in an upper part (the vicinity of a roof) of a rear windshield of the vehicle M and images an area including the rear side (the −X-axis direction in the drawing) of the vehicle M. The all-around cameras 11a to 11e capture images for the same usage. The all-around cameras 11a to 11e may have the same angle of view (imaging range). The imaging ranges of the all-around cameras 11a to 11e may overlap partially.

The LIDAR 12 is installed on the top (the roof) of the vehicle body and senses an object present in an area including the front side (the X-axis direction in the drawing) of the vehicle M.

The MVC 13a is installed on the front side of the vehicle body and images an area including the front side of the vehicle M. The MVC 13b is installed in the vicinity of a left sideview mirror of the vehicle M and images an area including the left side of the vehicle M. The MVC 13c is installed in the vicinity of a right sideview mirror of the vehicle M and images an area including the right side of the vehicle M. The MVC 13d is installed on the rear side of the vehicle body and images an area including the rear side of the vehicle M. The MVCs 13a to 13d capture images for the same usage. The MVCs 13a to 13d may have the same angle of view. The imaging ranges of the MVCs 13a to 13d may overlap partially.

The sonars 14a to 14l are installed, for example, in bumpers provided at a front end and a rear end of the vehicle body. The sonars 14a and 14b are installed at the front end portion of the vehicle body, the sonars 14c and 14d are installed at the front lateral ends of the vehicle body, and the sonars 14e and 14f are installed on the left and right sides of the front of the vehicle body. The sonars 14g and 14h are installed on the left and right sides of the rear of the vehicle body, and the sonars 14i, 14j, 14k, and 14l are installed in the rear end portion of the vehicle body. An object present near the vehicle M is detected by the sonars 14a to 14l. The sonars 14a to 14l perform a detection process for the same usage. The sonars 14a to 14l may have the same detection range. The detection ranges of the sonars 14a to 14l may overlap partially.

The cameras 15a and 15b are installed, for example, in an upper part of a front windshield or on a rear surface of a rearview mirror and image an area including the front side of the vehicle M. One of the cameras 15a and 15b may be a telescopic camera that can image a far area. One of the cameras 15a and 15b may be a main camera which normally operates, and the other thereof may be a sub camera which captures an image when imaging cannot be performed by the main camera. The imaging ranges of the cameras 15a and 15b may overlap partially.

The radar device 16a is installed in the vicinity of the front end of the vehicle body and detects an object present in front of the vehicle M. The radar device 16b is installed in the vicinity of the left-front side of the vehicle body and detects an object present on the left-front side and the left side of the vehicle M. The radar device 16c is installed in the vicinity of the right-front side of the vehicle body and detects an object present on the right-front side and the right side of the vehicle M. The radar device 16d is installed in the vicinity of the left-rear side of the vehicle body and detects an object present on the left-rear side and the left side of the vehicle M. The radar device 16e is installed in the vicinity of the right-rear side of the vehicle body and detects an object present on the right-rear side and the right side of the vehicle M. The radar devices 16a to 16e perform a detection process for the same usage. The radar devices 16a to 16e may have the same magnitude of detection range. The detection ranges of the radar devices 16a to 16e may overlap partially.

The number or positions of the external sensors 10 installed are not limited to the example illustrated in FIG. 3, and at least some thereof may be installed at different positions, the number of external sensors installed may be different, or some sensors may be added or deleted or may be different in types, for example, according to grades, generations (version), functions, and the like of the vehicle M.

### [Usage Example of External Sensor]

A usage example of the external sensor which is used to detect a surrounding situation will be divisionally described in some use cases. In the following description, it is assumed that no abnormality (defect) occurs in the external sensor 10, the processing device 100, the power supply 400, or the like, but the present invention is not limited thereto.

### <When Traveling on Expressway>

For example, when the vehicle M is traveling on an expressway, outputs (detection results) of the camera 15, the radar device 16, and the LIDAR 12 are used for start determination or end determination of TJP control and following travel determination. Outputs of the all-around camera 11 or the MVC 13 in addition to the sensors may be used for detection of excessive approach to an obstacle which is an ending condition of the TJP control. The outputs of the all-around camera 11 or the camera 15 are used for detection of approach to an emergency vehicle or a construction section in front of the vehicle M which is an ending condition of the TJP control. The outputs of the all-around camera 11 or the camera 15 are used for recognition of road marking lines used in driving control such as LKAS. The outputs of the all-around camera 11, the camera 15, and the radar device 16 are used for driving control (merging support) such as ALC. The outputs of the camera 15 are used for recognition of a toll gate or the like.

### <When Traveling on Regular Road>

For example, when the vehicle M is traveling on a regular road, the outputs of the camera 15 or the LIDAR 12 are used for driving control such as LKAS, hands-off at the time of traffic jam (automated driving), and recognition of marking lines in a narrow road, a construction section, or the like. The outputs of the camera 15 or the radar device 16 are used for detection of a nearby object (another vehicle or a pedestrian) or the like or recognition of a construction section. The recognition results of the all-around camera 11 or the camera 15 are used for recognition of a direction indicator of a nearby vehicle, a signal, a crossing, a stop line, a road marking, or the like. The detection results of the camera 15, the radar device 16, the LIDAR 12, the MVC 13, or the like are used for recognition of a travelable area near the vehicle M. When an object near the vehicle M is detected at the time of parking or exiting of the vehicle M or at the time of turning to left or right in traveling on a narrow road, the outputs of the sonar 14 or the radar device 16 are used.

### [Supply of Electric Power to External Sensor 10 and Processing Device 100]

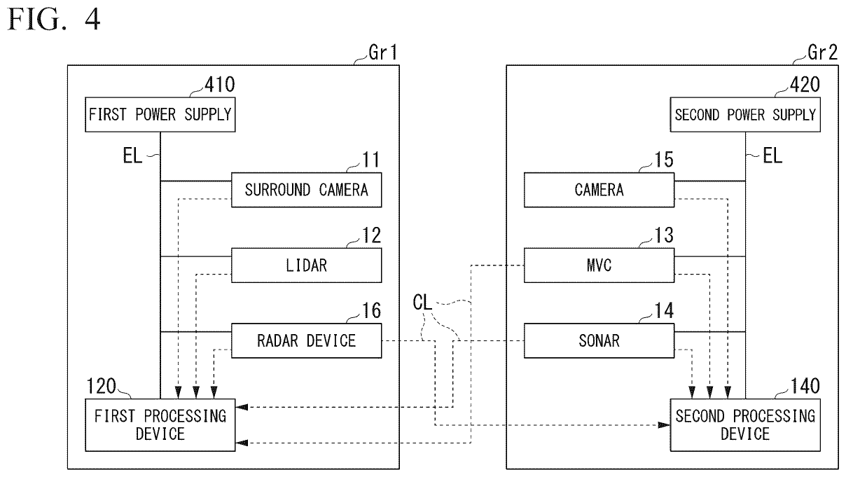

In the embodiment, for example, even when an abnormality such as a power supply defect occurs in the external sensor 10, the processing device 100, or the like, a redundant configuration is constructed such that detection (recognition) of a surrounding situation or driving control continues. FIG. 4 is a diagram illustrating an example of a redundant configuration including supply of electric power in the embodiment. In the example illustrated in FIG. 4, devices (the external sensor 10 and the processing device 100 in the example illustrated in FIG. 4) which are supplied with electric power from the first power supply 410 are referred to as a first group Gr1, and devices which are supplied with electric power from the second power supply 420 are referred to as a second group Gr2. In the example illustrated in FIG. 4, a solid line indicates an electrical line EL for supplying electric power, and a dotted line indicates a communication line CL representing a flow of information (for example, detection results from sensors).

In the embodiment, the first power supply 410 supplies electric power to at least the all-around camera (first sensor) 11 and the radar device (third sensor) 16 and supplies electric power to the first processing device 120. In the example illustrated in FIG. 4, the LIDAR 12 in addition to the all-around camera 11 and the radar device 16 is supplied with electric power from the first power supply 410. The all-around camera 11, the LIDAR 12, and the radar device 16 output their outputs (detection results) to the first processing device 120. In the example illustrated in FIG. 4, the communication line CL is provided such that the detection result of the radar device 16 is output to the second processing device 140.

In the embodiment, the second power supply 420 supplies electric power to at least the MVC (second sensor) 13 and supplies electric power to the second processing device 140. In the example illustrated in FIG. 4, the camera 15 and the sonar 14 in addition to the MVC 13 are supplied with electric power from the second power supply 420. The camera 15, the MVC 13, and the sonar 14 output their detection results to the second processing device 140. In the example illustrated in FIG. 4, the communication line CL is provided such that the detection results of the MVC 13 and the sonar 14 are output to the first processing device 120. In the embodiment, for example, driving control associated with automated driving is performed by the devices of the first group Gr1, and the surrounding situation of the vehicle M can be recognized with higher accuracy by also using the output of the MVC 13 or the sonar 14. In the embodiment, driving control associated with driving support is performed by the devices of the second group Gr2, and the surrounding situation of the vehicle M can be recognized with higher accuracy by also using the output of the radar device 16.

As illustrated in FIG. 4, the MVC 13, the radar device 16, and the sonar 14 include a communication line (first communication line) CL to the first processing device 120 and a communication line (second communication line) CL to the second processing device 140 to enable outputting from sensors through double systems, whereby it is possible to construct a more rigid redundant configuration.

In the embodiment, the first communication line and the second communication line may be communication lines of different communication bands. In this case, the first communication line is a communication network which has a larger capacity and a higher communication speed than the second communication line. Specifically, the first communication line is Ethernet and the second communication line is CAN, but the first communication line and the second communication line may be other communication networks. Accordingly, it is possible to enable communication with a large capacity with the first processing device 120 which requires a large amount of information for driving control such as automated driving without a delay.

In the embodiment, the first processing device 120 out of the first processing device 120 and the second processing device 140 may be increased in processing capacity. The processing capacity is, for example, a value which is compared using tera operations per second (TOPS), but is not limited thereto. As a result, since a larger amount of sensor information can be processed at a higher speed, it is possible to perform control associated with automated driving without a delay.

In the embodiment, for example, the first processing device 120 may recognize a surrounding situation of the vehicle M on the basis of the detection results from the external sensor 10, generate a target trajectory in the future of the vehicle M on the basis of the recognition result, output the generated target trajectory to the second processing device 140, and the second processing device 140 may output an instruction to the target actuator devices (the travel driving force output device 310, the brake device 320, and the steering device 330) on the basis of the target trajectory generated by the first processing device 120. In this way, by unifying the communication lines to the target actuator devices, it is possible to make adjustment, control, and the like unnecessary.

Each of the actuator devices (the travel driving force output device 310, the brake device 320, and the steering device 330) may include a communication line to the first processing device 120 in addition to the communication line to the second processing device 140. Accordingly, for example, even when a defect occurs in the second group Gr2 (the second processing device 140) and degraded driving is performed, it is possible to operate the actuator devices according to an instruction from the first processing device 120 of the first group Gr1 using the redundant configuration. In the embodiment, by constructing the redundant configuration of the aforementioned communication lines for the actuator devices (the travel driving force output device 310, the brake device 320, and the steering device 330) associated with traveling of the vehicle M instead of all the actuator devices included in the vehicle M, it is possible to curb costs and to realize more appropriate driving control at the time of degraded driving.

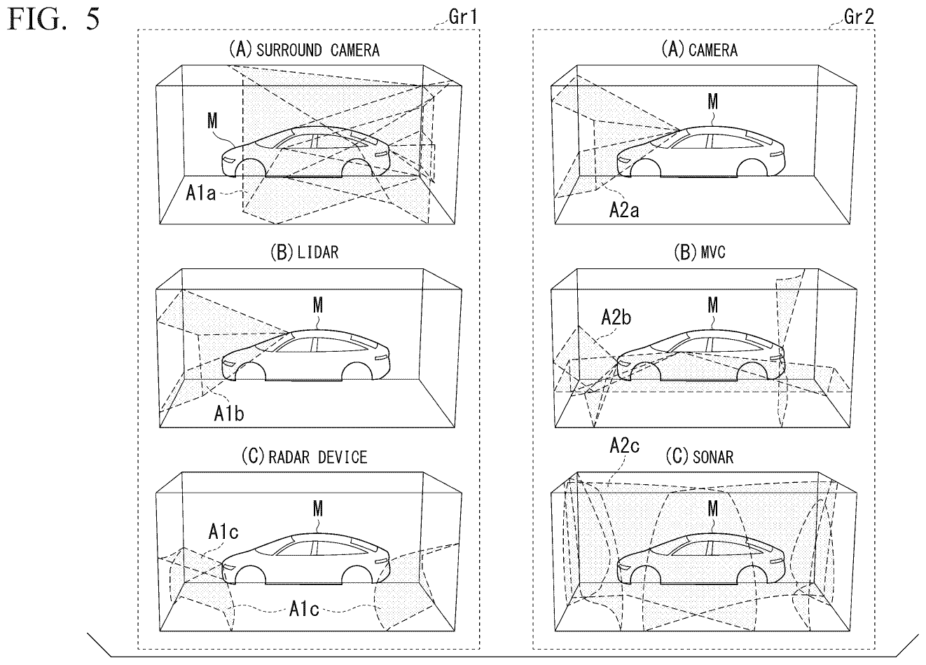

FIG. 5 is a diagram schematically illustrating detection ranges of the sensors included in the external sensor 10 according to the embodiment. In the example illustrated in FIG. 5, the detection range of the external sensor 10 included in the first group Gr1 supplied with electric power by the first power supply 410 and the detection range of the external sensor 10 included in the second group Gr2 which is supplied with electric power from the second power supply 420 are illustrated. In the example illustrated in FIG. 5, isolation of supply of electric power from the first power supply 410 and the second power supply 420 and the detection areas AR with a three-dimensional shape of the external sensors are schematically illustrated.

In (A) to (C) of the first group Gr1 illustrated in FIG. 5, a detection area Ala of the all-around camera 11, a detection range Alb of the LIDAR 12, and a detection range A1c of the radar device 16 with respect to the vehicle M are illustrated. In (A) to (C) of the second group Gr2 illustrated in FIG. 5, a detection area A2a of the camera 15, a detection range A2b of the MVC 13, and a detection range A2c of the sonar 14 with respect to the vehicle M are illustrated. It is possible to detect the surrounding situation of the vehicle M using only electric power from the first power supply 410 by combining the detection ranges in (A) to (C) of the first group Gr1 and to detect the surrounding situation of the vehicle M using only electric power from the second power supply 420 by combining the detection ranges in (A) to (C) of the second group Gr2. In this way, in the embodiment, the redundant configuration that can detect the surrounding situation of the vehicle M is constructed by supplying electric power from one of two power systems. Accordingly, even when one power supply becomes defective, it is possible to detect the surrounding situation of the vehicle M on the basis of the detection results of the external sensor operating with electric power supplied from the other power supply and to continuously perform corresponding driving control on the basis of the detection result.

### [Operation Control Under Defect]

Operation control under a defect in the redundant configuration according to the present embodiment will be specifically described below. For example, the defect determiner 160 determines whether a defect has occurred in one of the first group Gr1 and the second group Gr2. For example, the defect determiner 160 acquires the states of the first power supply 410 and the second power supply 420 using the vehicle sensor 230 and determines that a defect (an abnormality) has occurred in the corresponding group, for example, when the temperature is equal to or higher than a first threshold value, when a residual battery capacity is less than a second threshold value, or when a current value or a voltage value to be output exceeds a predetermined range. The defect determiner 160 may acquire the state of the electrical line EL or the communication line CL from the vehicle sensor 230 and determine that a defect has occurred in the corresponding group when it is determined that an abnormality such as disconnection or another communication error has occurred.

For example, when the defect determiner 160 determines that a defect has occurred in the first group Gr1, the processing device 100 detects the surrounding situation of the vehicle M using the external sensor 10 included in the second group Gr2, determines a stop position of the vehicle M, and causes the second processing device 140 to perform driving control (degraded driving) for moving and stopping the vehicle M to the determined stop position. When the defect determiner 160 determines that a defect has occurred in the second group Gr2, the processing device 100 detects the surrounding situation of the vehicle M using the external sensor 10 included in the first group Gr1, determines a stop position of the vehicle M, and causes the first processing device 120 to perform driving control (degraded driving) for moving and stopping the vehicle M to the determined stop position.

In this way, each of the first group Gr1 and the second group Gr2 includes the redundant configuration that can detect the all-around situation (360 degrees) around the vehicle M. Accordingly, even when one of the first group Gr1 and the second group Gr2 becomes defective as described above, it is possible to recognize the surrounding situation using the other group. According to the embodiment, since a surrounding situation at the small dead angle within a smaller distance can be detected using the sonar 14 or the MVC 13, it is possible to curb the vehicle M stopping in a no-parking/stopping area (for example, an area in front of a police station, an area in front of a fire station, or an area near a hydrant) or the like when the vehicle M is stopped through degraded driving.

### MODIFIED EXAMPLES

At least one of the first processing device 120 and the second processing device 140 in the embodiment may include a plurality of different ECUs. The vehicle system 1 may include different ECUs.

In the embodiment, the defect determiner 160 may perform determination of an abnormality (defect) for each device in the groups instead of determination of a defect for each group. For example, when the defect determiner 160 determines that an abnormality has occurred in only the first power supply 410, the processing device 100 may perform control such that the devices included in the first group Gr1 are supplied with electric power from the second power supply 420. For example, when the defect determiner 160 determines that the radar device 16 has a defect, the processing device 100 may output the detection results of the MVC 13 or the sonar 14 to the first processing device 120 such that the surrounding situation is recognized. Accordingly, it is possible to enhance continuity of driving control through partial modification.

In the embodiment, when the defect determiner 160 determines that a defect has occurred in both the first group Gr1 and the second group Gr2, the HMI 220 notifies a driver that driving control cannot be continued (and an instruction to perform manual driving) due to the defect, and driving control ends.

According to the aforementioned embodiment, the vehicle control device includes the external sensor 10 that detects a surrounding situation of the vehicle M, the processing device 100 that performs a predetermined process associated with the vehicle M on the basis of the output of the external sensor 10, the traveling control device 300 (which is an example of a control device) that controls at least traveling of the vehicle M on the basis of the process result from the processing device 100, and the power supply 400 that supplies electric power to at least the external sensor 10 and the processing device 100, the external sensor 10 includes the all-around camera 11 (which is an example of a first sensor), the MVC 13 (which is an example of a second sensor), and the radar device 16 (which is an example of a third sensor), the processing device 100 includes the first processing device 120 and the second processing device 140, the outputs of the all-around camera 11 and the MVC 13 are output to the first processing device 120, the output of the radar device 16 is output to the second processing device 140, the power supply 400 includes the first power supply 410 and the second power supply 420, the first power supply 410 supplies electric power to at least the all-around camera 11, the radar device 16, and the first processing device 120, and the second power supply 420 supplies electric power to at least the MVC 13 and the second processing device 140. Accordingly, it is possible to construct a more appropriate redundant configuration for the external sensor which is mounted in the vehicle.

Specifically, according to the embodiment, since the surrounding situation can be recognized even when a defect has occurred in a part by constructing a redundant configuration of a power supply for the external sensor 10, it is possible to more appropriately perform driving control such as degraded driving. According to the embodiment, by providing double output systems from the sensors, it is possible to construct a more rigid redundant configuration. Since outputs of sensors included in different groups can be used for recognition of the surrounding situation in the first processing device 120 and the second processing device 140, it is possible to more accurately recognize the surrounding situation on the basis of the outputs of more sensors. According to the embodiment, it is possible to make adjustment and control unnecessary by unifying the communication lines to the actuator devices.

While an embodiment of the present invention has been described above, the present invention is not limited to the embodiment, and various modifications and substitutions can be added thereto without departing from the gist of the present invention.

What is claimed is:

1. A vehicle control device comprising:
an external sensor detecting a surrounding situation of a vehicle;
a processing device performing a predetermined process associated with the vehicle on the basis of an output of the external sensor;
a control device controlling at least traveling of the vehicle on the basis of a process result of the processing device; and
a power supply supplying electric power to at least the external sensor and the processing device,
wherein the external sensor includes a first sensor, a second sensor, and a third sensor,
wherein the processing device includes a first processing device and a second processing device,
wherein outputs of the first sensor and the second sensor are output to the first processing device,
wherein an output of the third sensor is output to the second processing device,
wherein the power supply includes a first power supply and a second power supply,
wherein the first power supply supplies electric power to at least the first sensor, the third sensor, and the first processing device, and
wherein the second power supply supplies electric power to at least the second sensor and the second processing device.

2. The vehicle control device according to claim 1, wherein each of the first sensor and the second sensor includes a plurality of cameras imaging areas in a plurality of different directions from the vehicle, and
wherein the third sensor includes a plurality of radar devices detecting objects in a plurality of different directions from the vehicle.

3. The vehicle control device according to claim 1, wherein each of the first sensor and the second sensor includes a plurality of cameras having the same usage or the same angle of view, and
wherein the third sensor includes a plurality of radar devices detecting objects in a plurality of different directions from the vehicle.

4. The vehicle control device according to claim 1, wherein the second sensor is connected to the first processing device via a first communication line and is connected to the second processing device via a second communication line which is different from the first communication line.

5. The vehicle control device according to claim 4, wherein the first communication line is a communication network having a larger capacity and a higher communication speed than the second communication line.

6. The vehicle control device according to claim 1, wherein the first processing device has a larger processing capacity than the second processing device.

7. The vehicle control device according to claim 1, wherein the first processing device generates a target trajectory of the vehicle on the basis of an output of the external sensor, and
wherein the second processing device outputs an instruction to an actuator device included in the control device on the basis of the target trajectory generated by the first processing device.

8. The vehicle control device according to claim 7, wherein the actuator device includes a steering control device controlling steering of the vehicle and a speed control device controlling a speed of the vehicle, and
wherein the steering control device and the speed control device include a communication line via which an instruction from the second processing device is able to be received and a communication line via which an instruction from the first processing device is able to be received.

9. The vehicle control device according to claim 1, wherein the first power supply supplies electric power to a first group including at least the first sensor, the third sensor, and the first processing device,
wherein the second power supply supplies electric power to a second group including at least the second sensor and the second processing device, and
wherein, when one group of the first group and the second group is determined to be defective, the control device determines a stop position of the vehicle from the surrounding situation of the vehicle using the other group and performs vehicle control for causing the vehicle to travel to the determined stop position.

10. A vehicle control method comprising:
causing an external sensor to detect a surrounding situation of a vehicle;
causing a processing device to perform a predetermined process associated with the vehicle on the basis of an output of the external sensor;
controlling at least traveling of the vehicle on the basis of a process result of the processing device; and
causing a power supply to supply electric power to at least the external sensor and the processing device,
wherein the external sensor includes a first sensor, a second sensor, and a third sensor,
wherein the processing device includes a first processing device and a second processing device,
wherein outputs of the first sensor and the second sensor are output to the first processing device,
wherein an output of the third sensor is output to the second processing device,
wherein the power supply includes a first power supply and a second power supply,
wherein the first power supply supplies electric power to at least the first sensor, the third sensor, and the first processing device, and
wherein the second power supply supplies electric power to at least the second sensor and the second processing device.
